(19) United States
(12) Patent Application Publication
(10) Pub. No.: US 2015/0217752 A1
(43) Pub. Date: Aug. 6, 2015

(54) METHOD FOR OPERATING A MOTOR VEHICLE

(71) Applicant: Dr. Ing. h.c.F. Porsche Aktiengesellschaft, 70435 (DE)

(72) Inventor: Sebastian Rueger, Ludwigsburg (DE)

(21) Appl. No.: 14/613,387

(22) Filed: Feb. 4, 2015

(30) Foreign Application Priority Data
Feb. 6, 2014 (DE) 102014101466.9

(51) Int. Cl. B60W 10/06; B60W 10/08

(52) U.S. Cl. CPC B60W 10/06; B60W 10/08; B60W 2550/402; B60W 2710/06

(57) ABSTRACT

A method operates a motor vehicle having a hybrid drive with a first drive machine and a second drive machine, the first drive machine being an internal combustion engine and the second drive machine being an electric machine, operation of at least one of the drive machines requiring an adaptation in which the internal combustion engine is started. The method includes the use of a navigation device to identify at least one of a present position, a direction of travel or a travel route. An adaptation with a start of the internal combustion engine is postponed or eliminated based on at least one of present position data, present direction of travel data, present route data, predicted position data, predicted direction of travel data or predicted route data.

### CROSS REFERENCE TO RELATED APPLICATIONS

Priority is claimed to German Patent Application No. DE 10 2014 101 466.9, filed on Feb. 6, 2014, the entire disclosure of which is hereby incorporated by reference herein.

### FIELD

The invention relates to a method for operating a motor vehicle and to a motor vehicle of said type.

### BACKGROUND

Motor vehicles having a hybrid drive with a first drive machine and with a second drive machine, wherein one of the drive machines is an internal combustion engine and the second drive machine is an electric machine, are known. Said drive machines and the interaction thereof require an extremely wide variety of adaptations in order to ensure smooth, energy-efficient operation of the motor vehicle. For example, adaptations of the vehicle and/or of one or the other drive machine or of assemblies of the motor vehicle are necessary from time to time, such as the adaptation of a clutch in the drivetrain, of the internal combustion engine, of the gearbox in the drivetrain etc., in order to also ensure a comfortable change from operation of the electric machine to the internal combustion engine or vice versa.

Here, some adaptations can be carried out only while the internal combustion engine is in operation, because the operation thereof is imperatively necessary for the specific adaptation.

If there is a demand for an adaptation but the internal combustion engine is not in operation, it would be possible for the internal combustion engine to be started up in automated fashion.

However, if at the same time an operating situation is present in which the start-up of the internal combustion engine would be undesirable or would be considered to be rather unfavorable, the start-up of the internal combustion engine for adaptation purposes may lead to dissatisfaction.

### SUMMARY

In an embodiment, the present invention provides a method for operating a motor vehicle having a hybrid drive with a first drive machine and a second drive machine, the first drive machine being an internal combustion engine and the second drive machine being an electric machine, operation of at least one of the drive machines requiring an adaptation in which the internal combustion engine is started. The method includes the use of a navigation device to identify at least one of a present position, a direction of travel or a travel route. An adaptation with a start of the internal combustion engine is postponed or eliminated based on at least one of present position data, present direction of travel data, present route data, predicted position data, predicted direction of travel data or predicted route data.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic illustration of a motor vehicle according to an embodiment of the invention.

### DETAILED DESCRIPTION

An aspect of the present invention provides a method for the operation of a motor vehicle, in which method necessary adaptations are performed taking into consideration the present operating situation, wherein the method can be carried out in simple and uncomplicated fashion. It is also an object to specify a motor vehicle which is suitable for carrying out the method.

One exemplary embodiment of the invention relates to a method for operating a motor vehicle having a hybrid drive with a first drive machine and with a second drive machine, wherein one of the drive machines is an internal combustion engine, wherein the second drive machine is in particular an electric machine, wherein, for the operation of at least one of the drive machines, adaptations are necessary in which the internal combustion engine must be started, having a navigation device for identifying the present position and/or the direction of travel and/or the travel route, wherein an adaptation with a start of the internal combustion engine is postponed or eliminated in a manner dependent on present or predicted position data, direction of travel data and/or route data.

It is particularly advantageous if, in predetermined positions or areas, such as for example within cities or in “environmental protection zones” or areas of cities, an adaptation with a start of the internal combustion engine is postponed or eliminated.

Here, it is also advantageous if, after departing from the predetermined positions or areas, an adaptation with a start of the internal combustion engine is initiated.

It is likewise favorable if the time for a next adaptation to be performed is determined and, in a manner dependent on present or predicted position data, direction of travel data and/or route data, the time for the start of the adaptation is postponed to a predetermined later time.

It is also advantageous if the predetermined later time is a time at which the vehicle is in a position which is favorable for the start of the adaptation.

One exemplary embodiment of the invention relates to a motor vehicle having a hybrid drive with a first drive machine and with a second drive machine, wherein one of the drive machines is an internal combustion engine, wherein the second drive machine is in particular an electric machine, wherein, for the operation of at least one of the drive machines, adaptations are necessary in which the internal combustion engine must be started, having a navigation device for identifying the present position and/or the direction of travel and/or the travel route, for carrying out a method according to the invention.

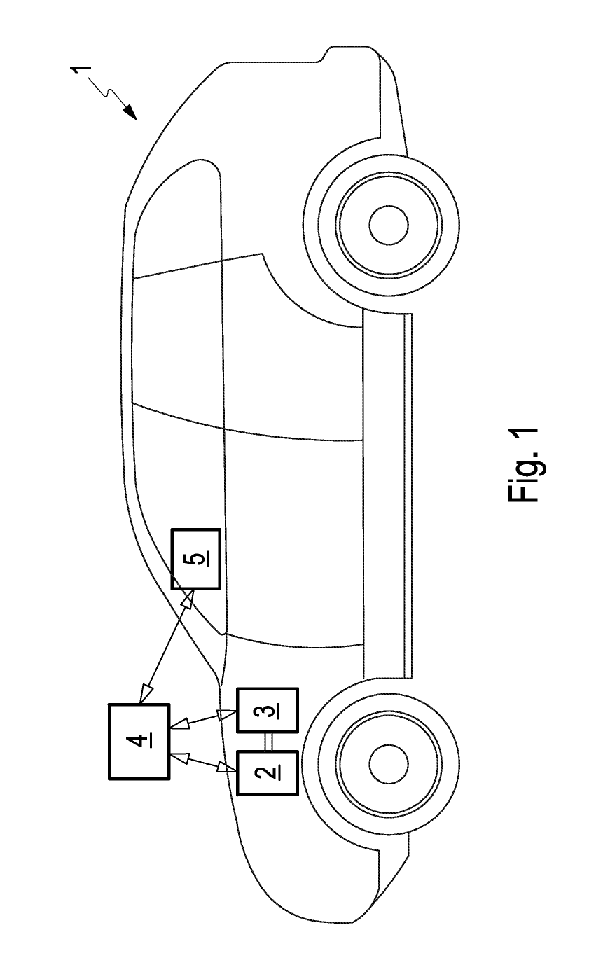

FIG. 1 shows an exemplary embodiment of a motor vehicle 1 having a hybrid drive with a first drive machine 2 and with a second drive machine 3, wherein one of the drive machines, for example the first drive machine 2, is an internal combustion engine, wherein the second drive machine 3 is in particular an electric machine.

For the operation of at least one of the drive machines 2, 3, adaptations are necessary. These are controlled for example by a control unit 4.

For some of the adaptations to be carried out, the internal combustion engine must be started. This is however in particular not always advantageous. In this case, it may be disadvantageous for said adaptation with a start of the internal combustion engine to take place for example in a city environment or in a predefined district where the operation of the internal combustion engine is rather unfavorable or undesirable.

The motor vehicle is furthermore equipped with a navigation device 5 for identifying the present position and/or the direction of travel and/or the travel route of the motor vehicle.

For the control of the adaptations, it is now the case that the present position, the direction of travel and/or the present route are taken into consideration, wherein the adaptations are performed in a manner dependent on present or predicted position data, direction of travel data and/or route data, wherein an adaptation with a start of the internal combustion engine is postponed or eliminated if it is identified that this appears unfavorable at the present operating point.

It is also favorable if, in predetermined position or areas, such as for example within cities or areas of cities, an adaptation with a start of the internal combustion engine is postponed or eliminated.

According to an embodiment of the invention, after departing from the predetermined positions or areas, an adaptation with a start of the internal combustion engine is initiated.

Furthermore, according to an embodiment of the invention, it is favorable if the time for a next adaptation to be performed is determined and, in a manner dependent on present or predicted position data, direction of travel data and/or route data, the time for the start of the adaptation is postponed to a predetermined later time. The predetermined later time may be a time at which the vehicle is in a position which is favorable for the start of the adaptation, such as for example outside a city or a predefined district or area.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for operating a motor vehicle having a hybrid drive with a first drive machine and a second drive machine, the first drive machine being an internal combustion engine and the second drive machine being an electric machine, operation of at least one of the drive machines requiring an adaptation in which the internal combustion engine is started, the method comprising:
using a navigation device to identify at least one of a present position, a direction of travel or a travel route, and
postponing or eliminating an adaptation with a start of the internal combustion engine based on at least one of present position data, present direction of travel data, present route data, predicted position data, predicted direction of travel data or predicted route data.

2. The method as recited in claim 1, wherein the at least one of postponing or eliminating the adaptation with a start of the internal combustion engine is carried out in predetermined positions or areas.

3. The method as recited in claim 2, wherein the predetermined positions or areas include within a city.

4. The method as recited in claim 2, wherein the predetermined positions or areas include a vicinity of a city

5. The method as recited in claim 1, further comprising initiating the adaptation with a start of the internal combustion engine after departing from a predetermined position or area.

6. The method as recited in claim 1, further comprising determining a time for a next adaptation to be performed and postponing the start of the adaptation to a predetermined later time based on the at least one of present position data, present direction of travel data, present route data, predicted position data, predicted direction of travel data or predicted route data.

7. The method as recited in claim 6, wherein the predetermined later time is a time at which the vehicle is in a position which is favorable for the start of the adaptation.

8. A motor vehicle comprising:
a hybrid drive with a first drive machine and with a second drive machine, the first drive machine being an internal combustion engine and the second drive machine being an electric machine, operation of at least one of the drive machines requiring an adaptation in which the internal combustion engine is started;
a navigation device for identifying at least one of a present position, a direction of travel or a travel route; and
a control unit configured to postpone or eliminate an adaptation with a start of the internal combustion engine based on at least one of present position data, present direction of travel data, present route data, predicted position data, predicted direction of travel data or predicted route data.
